(19) United States
(12) Patent Application Publication
(10) Pub. No.: US 2017/0240807 A1
(43) Pub. Date: Aug. 24, 2017

(54) LUMINOUS BODY AND METHOD FOR PRODUCING SAME

(71) Applicant: LUMINESSUS. INC, Tokyo (JP)

(72) Inventor: Masao SUZUKI, Osaka-shi (JP)

(73) Assignees: LUMINESSUS. INC, Tokyo (JP); NIC Corportion, Osaka-shi, Osaka (JP)

(21) Appl. No.: 15/519,495

(22) PCT Filed: Oct. 6, 2015
(86) PCT No.: PCT/JP2015/078256

§ 371 Date: Apr. 14, 2017

(30) Foreign Application Priority Data
Oct. 14, 2014 (JP) 2014-209995

(51) Int. Cl. C09K 11/02; C09K 11/77

(52) U.S. Cl. CPC C09K 11/025; C09K 11/7792

(57) ABSTRACT

The present invention provides a luminous body having an improved chemical resistance, and to a method for producing the same. The luminous body of the present invention contains a strontium-containing fluorescent particle in which a specified condensed phosphate is deposited in an amount of 0.2 to 15.0 wt %, and amorphous silica with which the surface of the fluorescent particle is coated. The luminous body of the present invention can be suitably produced by obtaining a condensed phosphate-coated fluorescent particle in which a specified condensed phosphate is deposited on the surface of the strontium-containing fluorescent particle in an amount of 0.2 to 15.0 wt %, washing the resulting solid with water until the electrical conductivity conductivity comes to be 450 μS or less, and adding sodium silicate and an acid to a slurry in which the particle is dispersed in water to deposit amorphous silica.

### FIELD OF THE INVENTION

The present invention relates to a luminous body having an improved chemical resistance, and to a method for producing the same.

### BACKGROUND ART

Fluorescent substances that absorb light energy and generate fluorescence are known. Since fluorescent substances generate fluorescence without electrical conductivity power supplied from an external source, the fluorescent substances have been widely used for, for example, safety signs at night, clothes, and ornaments. Fluorescent substances are also widely used in other applications.

However, conventional fluorescent substances have problems in terms of, for example, water resistance, heat resistance, and easy processability. That is, the fluorescent substances are generally water susceptible. When the fluorescent substances are exposed to moisture, they are hydrolyzed and the properties thereof are deteriorated. In addition, when the fluorescent substances are heated to a high temperature, the luminance is remarkably decreased. Therefore, for example, it is difficult to produce a molded article by mixing a fluorescent substance with a resin at a high temperature. Further, since the fluorescent substances have large resistances due to multiple concave and convex structures on the surface, it is difficult to use the fluorescent substances for painting materials.

Patent Document 1 discloses a luminous particle which is coated with a thin silica film having a refractive index of 1.435 or more (a first coating) and is further coated with a silica film derived from a polysilazane having a refractive index of 1.45 or more (a second coating). Patent Document 1 discloses that the moisture resistance of the luminous particle is improved by the structure.

### PRIOR ART DOCUMENTS

### Patent Documents

Patent Document 1: JP 2003-261869 A

### SUMMARY OF THE INVENTION

### Problems to be Solved by the Invention

However, since the luminous particle disclosed in Patent Document 1 has a dual-coating structure containing silica, the preparation is not necessary suitable for manufacturing industries. If the luminous particle has a single-coating structure, the sufficient water resistance cannot be realized, and the chemical resistance is not sufficient.

Therefore, the object of the present invention is to provide a luminous body having an improved chemical resistance, and to a method for producing the same.

### Means for Solving the Problems

The present invention is a method for producing a luminous body and a luminous body obtained by the method, the method comprising the steps of:

(a-1) dispersing a fluorescent particle that is a strontium-containing phosphorescent pigment in water to obtain a slurry (S1);

(a-2) adding sodium tripolyphosphate or sodium tetrapolyphosphate as well as a salt of a metal which is selected from calcium, strontium, barium, aluminum, zinc, and cerium to the slurry (S1) to obtain a condensed phosphate-coated fluorescent particle in which a condensed phosphate is deposited on the surface of the fluorescent particle in an amount of 0.2 to 15.0 wt % with respect to the weight of the fluorescent particle;

(a-3) washing the resulting solid with water until the electrical conductivity conductivity comes to be 450 μS or less;

(b-1) dispersing the condensed phosphate-coated fluorescent particle in water to obtain a slurry (S2); and

(b-2) adding sodium silicate and an acid to the slurry (S2) to deposit amorphous silica on the surface of the condensed phosphate-coated fluorescent particle.

The present invention is a luminous body comprising:

a fluorescent particle that is a strontium-containing phosphorescent pigment, in which a condensed phosphate is deposited on the surface of the fluorescent particle in an amount of 0.2 to 15.0 wt %; and

amorphous silica with which the surface of the fluorescent particle is coated;

wherein the condensed phosphate is a tripolyphosphate or tetrapolyphosphate salt of a metal which is selected from calcium, strontium, barium, aluminum, zinc, and cerium.

### Effect of the Invention

The present invention can provide a luminous body having an improved chemical resistance.

### MODE FOR CARRYING OUT THE INVENTION

### <Luminous Body>

The luminous body of the present invention has a structure in which the surface of a fluorescent particle is coated with an amorphous silica. In other words, the luminous body of the present invention is a microencapsulated fluorescent particle with the amorphous silica. In the luminous body of the present invention, it is preferable that the whole surface of the fluorescent particle is coated with the amorphous silica; however, a part of the fluorescent particle may not be coated with the amorphous silica. In the luminous body of the present invention, the amorphous silica is preferably formed as an outermost layer of the luminous body.

The luminous body having an improved chemical resistance (acid resistance and alkali resistance) is obtained by coating the surface of the fluorescent particle with the amorphous silica. The luminous body also has an improved water resistance, heat resistance, and weather resistance. Further, since the concave and convex structures on the surface of the fluorescent particle is decreased by the coating with the amorphous silica, the viscous resistance is decreased and the handleability is improved. For example, when a luminous body having a low viscous resistance is used as a painting material, the spreadability of the painting material is increased and the usability is improved. In addition, when a luminous body having less concave and convex structures is supplied to a molding machine for molding process, the molding machine is prevented from wearing and damaging by the luminous body.

In the present invention, a strontium-containing phosphorescent pigment (self-luminous pigment) is used as the fluorescent particle. Examples of the strontium-containing phosphorescent pigment include materials containing strontium aluminate as a main ingredient and an activator such as europium or dysprosium added as an activator, and concrete examples include SrAl₂O₄:Eu,Dy; and Sr₄Al₁₄O₂₅:Eu,Dy.

The particle size of the fluorescent particle is suitably selected depending on the purpose. For example, fluorescent particles having a particle size uniformed to the range of 2 to 100 μm can be used. The fluorescent particles having a uniformed particle size of 15 to 50 μm, 15 to 25 μm, 25 to 35 μm, or 35 to 50 μm can also be used. The “particle size uniformed to the range of . . . ” preferably means the condition that the all fluorescent particles have a particle size within the range by classification; however, a small amount of the particles may have a particle size out of the range and, it may means the condition, for example, that 95 number % of the fluorescent particles have a particle size within the range.

When the fluorescent particles have a particle size uniformed to a predetermined range, high luminance can be realized. That is, since the fluorescent particles contain less impurities or fluorescent particles having a smaller particle size, irregular reflection of the light emitted from the fluorescent particles is difficult to occur, and thereby high luminance can be realized. When the particle size is larger, the amount of light energy accumulated in the fluorescent particles is increased, and thereby the emitting time becomes longer. However, since the fluorescent particles have rough feeling, the handling becomes inconvenient. Therefore, the fluorescent particles suitably have a particle size uniformed to the range of 2 to 100 μm.

The surface of the fluorescent particle is surface-treated with a condensed phosphate. That is, the condensed phosphate is deposited on the surface of the fluorescent particle. When the fluorescent particle which is surface-treated with the condensed phosphate is used, the fluorescent particle more strongly adheres to the amorphous silica, and various resistances are further improved. The amount of the condensed phosphate deposited on the surface of the fluorescent particle is 0.2 to 15.0 wt % with respect to the fluorescent particle. If the amount of the condensed phosphate is increased, the fluorescent particle more strongly adheres to the amorphous silica, and various resistances are further improved. However, even if the amount is increased beyond the required amount, the effect becomes plateau. The amount of the condensed phosphate deposited on the surface of the fluorescent particle is preferably 0.5 to 10.0 wt %, more preferably 1.0 to 6.0 wt %, and further preferably 2.0 to 4.0 wt %, with respect to the fluorescent particle. The method for surface-treating the fluorescent particle with the condensed phosphate will be described later.

As the condensed phosphate, a tripolyphosphate or tetrapolyphosphate salt of a metal which is selected from calcium, strontium, barium, aluminum, zinc, and cerium is used. That is, examples of the condensed phosphate which can be used include calcium tripolyphosphate, strontium tripolyphosphate, barium tripolyphosphate, aluminum tripolyphosphate, zinc tripolyphosphate, and cerium tripolyphosphate; and metal tetrapolyphosphates such as calcium tetrapolyphosphate, strontium tetrapolyphosphate, barium tetrapolyphosphate, zinc tetrapolyphosphate, and cerium tetrapolyphosphate.

The coating thickness of the amorphous silica with which the surface of the fluorescent particle is coated may be suitably selected depending on the targeted water resistance, heat resistance, and handleability. The average coating thickness is preferably 50 to 5,000 Å, more preferably 10 to 1,000 Å, and further preferably 200 to 5,000 Å. When the average coating thickness of the amorphous silica is increased, the fluorescent particle is sufficiently coated with the amorphous silica, and thereby the various resistances such as chemical resistance of the luminous body are improved. On the other hand, when the average coating thickness of the amorphous silica is decreased, the fluorescent particle easily absorbs light from outside and the light emitted from the fluorescent particle is easily passed through the coating of the amorphous silica into outside, and thereby the luminance of the luminous body is improved. The average coating thickness of the amorphous silica with which the surface of the fluorescent particle is coated can be calculated by using the particle size of the resulting luminous body and the particle size of the fluorescent particle used.

The content of the amorphous silica is preferably 1 to 25 wt %, more preferably 5 to 15 wt %, and further preferably 7 to 10 wt %, and may be 8 wt %, for example. When the content of the amorphous silica is increased, the fluorescent particle is sufficiently coated with the amorphous silica, and thereby the various resistances such as chemical resistance of the luminous body are improved. On the other hand, when the content of the amorphous silica is decreased, the fluorescent particle easily absorbs light from outside and the light emitted from the fluorescent particle is easily passed through the coating of the amorphous silica into outside, and thereby the luminance of the luminous body is improved. The content of the amorphous silica can be calculated by using the weight of the resulting amorphous silica and the weight of the fluorescent particle used.

The luminous body of the present invention is used by adding it to a paint, a plastic, a synthetic rubber, a building material, or the like.

### <Method for Producing the Luminous Body>

The luminous body as described above can be produced by depositing orthosilicic acid on the surface of the fluorescent particle at a high temperature. Examples of the method for obtaining orthosilicic acid include, for example, the methods as follows:

(1) Sodium silicate and an acid are added.

(2) Ethyl orthosilicate is hydrolyzed.

(3) Sodium silicate is treated with a cation exchange resin.

(4) Glass is reacted with sodium hydroxide in an autoclave.

In the method (2), since ethyl alcohol resulted from the hydrolysis is vaporized, an apparatus for collecting ethyl alcohol is required. In the method (3), the resulting orthosilicic acid is easily decomposed, and it is difficult to deposit orthosilicic acid on the surface of the fluorescent particle. Further, the properties of the cation exchange resin are easily decreased, and the regeneration of the cation exchange resin is difficult. The method (4) is not suitable for industrial production because of using an autoclave.

Therefore, in the present invention, orthosilicic acid is preferably deposited on the surface of the fluorescent particle by the method (1). In order to make the fluorescent particle strongly adhere with the amorphous silica and to improve various resistances, the condensed phosphate is preferably deposited on the surface of the fluorescent particle in advance. The method will now be described in more detail.

Firstly, a condensed phosphate is deposited on the surface of the fluorescent particle to form a condensed phosphate-coated fluorescent particle (step (a)). That is, the surface of the fluorescent particle is surface-treated with a condensed phosphate. The fluorescent particle as described above can be used.

As the condensed phosphate, a tripolyphosphate or tetrapolyphosphate salt of a metal which is selected from calcium, strontium, barium, aluminum, zinc, and cerium is used, as described above. That is, examples of the condensed phosphate which can be used include calcium tripolyphosphate, strontium tripolyphosphate, barium tripolyphosphate, aluminum tripolyphosphate, zinc tripolyphosphate, and cerium tripolyphosphate; and metal tetrapolyphosphates such as calcium tetrapolyphosphate, strontium tetrapolyphosphate, barium tetrapolyphosphate, zinc tetrapolyphosphate, and cerium tetrapolyphosphate.

As the method for depositing the condensed phosphate on the surface of the fluorescent particle, a method by dispersing a fluorescent particle that is a strontium-containing phosphorescent pigment in water to obtain a slurry (S1) (step (a-1)), and thereafter by adding sodium tripolyphosphate or sodium tetrapolyphosphate as well as a salt of a metal which is selected from calcium, strontium, barium, aluminum, zinc, and cerium to the slurry (S1) (step (a-2)) is employed. That is, in the slurry (S1) containing the fluorescent particle, the condensed phosphate is formed by a condensed phosphate ion resulted from the condensed sodium phosphate and a metal ion resulted from the salt of the metal.

As the condensed sodium phosphate, sodium salt of a condensed phosphoric acid corresponding to the condensed phosphate deposited on the surface of the fluorescent particle may be used. When a tripolyphosphate is deposited, sodium tripolyphosphate may be used. When a tetrapolyphosphate is deposited, sodium tetrapolyphosphate may be used. As the salt of the metal, a salt of the metal (calcium, strontium, barium, aluminum, zinc, or cerium) corresponding to the condensed phosphate deposited on the surface of the fluorescent particle may be used. Examples of the salt of the metal include chlorides, nitrates, and sulfate.

The condensed phosphate-coated fluorescent particle can be obtained by filtering and drying the solid resulted from the step (a-2). In this step, the resulting solid is washed with water until the electrical conductivity conductivity comes to be 450 μS or less (step (a-3)). By this operation, the concentration of an alkali metal ion can be decreased in the step (b-2) described later.

As described above, the amount of the condensed phosphate deposited on the surface of the fluorescent particle is 0.2 to 15.0 wt % with respect to the fluorescent particle. If the amount of the condensed phosphate is increased, the fluorescent particle more strongly adheres to the amorphous silica, and various resistances are further improved. However, even if the amount is increased beyond the required amount, the effect becomes plateau. The amount of the condensed phosphate deposited on the surface of the fluorescent particle is preferably 0.5 to 10.0 wt %, more preferably 1.0 to 6.0 wt %, and further preferably 2.0 to 4.0 wt %, with respect to the fluorescent particle.

Next, the amorphous silica is deposited on the surface of the resulting condensed phosphate-coated fluorescent particle (step (b)). As the method, a method by dispersing the condensed phosphate-coated fluorescent particle in water to obtain a slurry (S2) (step (b-1)), and thereafter by adding sodium silicate and an acid to the slurry (S2) (step (b-2)) is employed. By this operation, the luminous body of the present invention can be obtained.

In the step (b-1), sodium silicate or sodium hexametaphosphate is preferably used as a dispersant. By this operation, the condensed phosphate-coated fluorescent particle is easily dispersed as a primary particle in water. When the proportion of the condensed phosphate-coated fluorescent particle dispersed as a primary particle is increased, the fluorescent particle is easily coated with the amorphous silica. That is, if the amorphous silica is formed as a secondary particle aggregate, the aggregate is broken when the amorphous silica is dried and ground or the amorphous silica is dispersed into a resin, and the surface without the coating of the amorphous silica is easily exposed. The amount of the dispersant used is preferably 1 to 10 parts by weight, more preferably 2 to 7 parts by weight, and further more preferably 3 to 5 parts by weight, with respect to 100 parts by weight of the condensed phosphate-coated fluorescent particle.

Examples of the acid added in the step (b-2) include sulfuric acid, hydrochloric acid, nitric acid, and ammonium nitrate. If a volatile acid is used, an apparatus for collecting the acid is required for securing good working environment. Therefore, a nonvolatile acid is preferably used, and sulfuric acid is more preferably used.

The temperature of the slurry (S2) is preferably kept at 60° C. or more when the step (b-2) is performed. When the temperature of the slurry (S2) is kept at a high level, the formation of the amorphous silica is accelerated. The temperature of the slurry (S2) is preferably kept at 80° C. or more, more preferably kept at 85° C. or more, further preferably kept at 90° C. or more, and particularly preferably kept at 95° C. or more. The temperature of the slurry (S2) when the step (b-2) is performed is generally 100° C. or more, but the temperature may be lower than 100° C.

The pH of the slurry (S2) is preferably kept at 6 or more when the step (b-2) is performed. When the pH of the slurry (S2) is kept at a high level, a porous gelatinous silica is difficult to be precipitated. The pH of the slurry (S2) is preferably kept at 8 or more, more preferably kept at 9 or more, further preferably kept 9.5 or more, and particularly preferably kept at 10 or more. The pH of the slurry (S2) when the step (b-2) is performed is generally 11 or less.

The concentration of the alkali metal ion is preferably kept at 1.0 N (normality) or less when the step (b-2) is performed. By this condition, the formation of aggregates can be prevented. The concentration of the alkali metal ion is more preferably kept at 0.1 N (normality) or less, further preferably kept at 0.03 N (normality) or less, and particularly preferably kept at 0.02 N (normality) or less. The concentration of an alkali metal ion when the step (b-2) is performed is preferably as low as possible, but the concentration may be 0.001 N (normality) or more, for example.

A luminous body in which the surface of a fluorescent particle is coated with an amorphous silica can be produced by the method as described above.

### EXAMPLES

The present invention will now be specifically described with reference to the examples. In the examples, “part(s)” means “part(s) by weight”, and “%” means “wt %”.

### Example 1

To 2,500 parts of water, 100 parts of a phosphorescent pigment (produced by Ryoko Co. Ltd., trade name: KURAITO BLIGHT, compositional formula: Sr₄Al₁₄O₂₅:Eu,Dy, particle size: 2 to 100 μm) was added, and the resulting mixture was heated to 60° C. with stirring. A solution of 2.0 parts of sodium tripolyphosphate (56.5 to 58.0% as P₂O₅) in 100 parts of water was added to the resulting slurry for about 15 minutes. After stirring for 15 minutes, a solution of 4.0 parts of barium chloride (BaCl₂.2H₂O) in 100 parts of water was added to the resulting slurry for about 15 minutes. After stirring for 15 minutes, the pH of the slurry was adjusted to 7.0, and the slurry was then filtered with washing with water until the electrical conductivity conductivity of the slurry came to be 450 μS. The resulting solid was dried and ground to deposit barium tripolyphosphate on the surface of the phosphorescent pigment. The amount of barium tripolyphosphate deposited on the surface of the phosphorescent pigment was 3.2% based on the phosphorescent pigment.

To 1,600 parts of water, 100 parts of the surface-treated phosphorescent pigment was added, and the resulting mixture was heated to 60° C. with stirring. A solution of 3.5 parts of sodium silicate (SiO₂: 28.5%, Na₂O: 10%) in 20 parts of water was added to the resulting slurry, and the resulting mixture was further heated to 90° C. with stirring. In this stage, the pH of the slurry was 9.0 to 10.0.

Next, a solution of 27 parts of sodium silicate (SiO₂: 28.5%, Na₂O: 10%) in 120 parts of water and a solution of 43 parts of 98% sulfuric acid in 120 parts of water were added simultaneously to the slurry at 10 parts per 10 minutes (the period for adding was about 120 minutes). During adding, the temperature of the slurry was carefully kept at a temperature of 95° C. or more and the pH of the slurry was carefully kept over 9.0. After 30 minutes after completion of adding, the slurry was neutralized with 98% sulfuric acid so as to have a pH of 6.0. After further stirring for 30 minutes, the slurry was filtered with washing with water. The resulting solid was dried and ground to obtain an amorphous silica-coated phosphorescent pigment sample 1 in which the phosphorescent pigment was microencapsulated with an amorphous silica. The content of the amorphous silica in the sample 1 was 8.0%, and the average coating thickness of the amorphous silica was 300 Å.

### Example 2

An amorphous silica-coated phosphorescent pigment sample 2 was obtained by the same method as in Example 1, except that 2.3 parts of zinc chloride (ZnCl₂) was used instead of 4.0 parts of barium chloride (BaCl₂.2H₂O), in order to deposit zinc tripolyphosphate on the surface of the phosphorescent pigment. The amount of zinc tripolyphosphate deposited on the surface of the phosphorescent pigment was 2.2% with respect to the weight of the phosphorescent pigment. The content of the amorphous silica in the sample 2 was 8.0%, and the average coating thickness of the amorphous silica was 300 Å.

### Example 3

An amorphous silica-coated phosphorescent pigment sample 3 was obtained by the same method as in Example 1, except that 4.7 parts of cerium nitrate (Ce(NO₃)₃.6H₂O) was used instead of 4.0 parts of barium chloride (BaCl₂.2H₂O), in order to deposit cerium tripolyphosphate on the surface of the phosphorescent pigment. The amount of cerium tripolyphosphate deposited on the surface of the phosphorescent pigment was 2.6% with respect to the weight of the phosphorescent pigment. The content of the amorphous silica in the sample 3 was 8.0%, and the average coating thickness of the amorphous silica was 300 Å.

### Example 4

An amorphous silica-coated phosphorescent pigment sample 4 was obtained by the same method as in Example 1, except that 1.8 parts of sodium tetrapolyphosphate (61.0 to 63.0% as P₂O₅) was used instead of 2.0 parts of sodium tripolyphosphate and that 2.0 parts of calcium chloride (CaCl₂) was used instead of 4.0 parts of barium chloride (BaCl₂.2H₂O), in order to deposit calcium tetrapolyphosphate on the surface of the phosphorescent pigment. The amount of calcium tetrapolyphosphate deposited on the surface of the phosphorescent pigment was 3.2% with respect to the weight of the phosphorescent pigment. The content of the amorphous silica in the sample 4 was 8.0%, and the average coating thickness of the amorphous silica was 300 Å.

### Example 5

An amorphous silica-coated phosphorescent pigment sample 5 was obtained by the same method as in Example 1, except that 1.8 parts of sodium tetrapolyphosphate (61.0 to 63.0% as P₂O₅) was used instead of 2.0 parts of sodium tripolyphosphate and that 4.0 parts of aluminum chloride (AlCl₃.6H₂O) was used instead of 4.0 parts of barium chloride (BaCl₂.2H₂O), in order to deposit aluminum tetrapolyphosphate on the surface of the phosphorescent pigment. The amount of aluminum tetrapolyphosphate deposited on the surface of the phosphorescent pigment was 2.4% with respect to the weight of the phosphorescent pigment. The content of the amorphous silica in the sample 5 was 8.0%, and the average coating thickness of the amorphous silica was 300 Å.

### Example 6

An amorphous silica-coated phosphorescent pigment sample 6 was obtained by the same method as in Example 1, except that 1.8 parts of sodium tetrapolyphosphate (61.0 to 63.0% as P₂O₅) was used instead of 2.0 parts of sodium tripolyphosphate and that 4.7 parts of cerium nitrate (Ce(NO₃)₃.6H₂O) was used instead of 4.0 parts of barium chloride (BaCl₂.2H₂O), in order to deposit cerium tetrapolyphosphate on the surface of the phosphorescent pigment. The amount of cerium tetrapolyphosphate deposited on the surface of the phosphorescent pigment was 3.3% with respect to the weight of the phosphorescent pigment. The content of the amorphous silica in the sample 6 was 8.0%, and the average coating thickness of the amorphous silica was 300 Å.

### Comparative Example 1

The phosphorescent pigment used in Example 1 was used at it is as a sample 7, which is not microencapsulated with amorphous silica.

### <Evaluation>

An acid resistance test, an alkali resistance test, and a dispersibility test were performed for each sample. Based on the result from each test, each sample was evaluated with the following 8 ratings.

“8”: extremely excellent

“7”: excellent

“6”: extremely good

“5”: good

“4”: average

“3”: acceptable

“2”: slightly acceptable

“1”: unacceptable

### <Acid Resistance Test>

Acid resistance was evaluated by dipping each sample in 2% H₂SO₄ solution, and then measuring the luminance of each sample before and after dipping, in accordance with JIS K5101-8.

### <Alkali Resistance Test>

Alkali resistance was evaluated by dipping each sample in 1% NaOH solution, and then measuring the luminance of each sample before and after dipping, in accordance with JIS K5101-8.

### <Dispersibility Test>

Dispersibility was evaluated with paint conditioner method using a melamine alkyd resin, in accordance with JIS K5101-5-2.

TABLE 1

| Sample | Acid | Alkali | |
|---|---|---|---|
| No | resistance | resistance | Dispersibility |
| 1 | 7 | 5 | 6 |
| 2 | 5 | 6 | 5 |
| 3 | 8 | 7 | 5 |
| 4 | 7 | 6 | 4 |
| 5 | 8 | 6 | 5 |
| 6 | 8 | 7 | 5 |
| 7 | 1 | 1 | 4 |

As described above, it is found that a luminous body having an improved acid resistance and alkali resistance is obtained from the present invention.

1. A method for producing a luminous body, comprising the steps of:
(a-1) dispersing a fluorescent particle that is a strontium-containing phosphorescent pigment in water to obtain a slurry (S1);
(a-2) adding sodium tripolyphosphate or sodium tetrapolyphosphate as well as a salt of a metal which is selected from calcium, strontium, barium, aluminum, zinc, and cerium to the slurry (S1) to obtain a condensed phosphate-coated fluorescent particle in which a condensed phosphate is deposited on the surface of the fluorescent particle in an amount of 0.2 to 15.0 wt % with respect to the weight of the fluorescent particle;
(a-3) washing the resulting solid with water until the electrical conductivity conductivity comes to be 450 μS or less;
(b-1) dispersing the condensed phosphate-coated fluorescent particle in water to obtain a slurry (S2); and
(b-2) adding sodium silicate and an acid to the slurry (S2) to deposit amorphous silica on the surface of the condensed phosphate-coated fluorescent particle.

2. The method for producing a luminous body according to claim 1, wherein the strontium-containing phosphorescent pigment contains strontium aluminate and an activator added thereto.

3. The method for producing a luminous body according to claim 2, wherein the strontium-containing phosphorescent pigment is SrAl₂O₄:Eu,Dy or Sr₄Al₁₄O₂₅:Eu,Dy.

4. The method for producing a luminous body according to claim 1, wherein the condensed phosphate is barium tripolyphosphate, zinc tripolyphosphate, cerium tripolyphosphate, calcium tetrapolyphosphate, aluminum tetrapolyphosphate, or cerium tetrapolyphosphate.

5. The method for producing a luminous body according to claim 1, wherein the amount of the condensed phosphate deposited on the surface of the fluorescent particle is 0.2 to 4.0 wt % with respect to the weight of the fluorescent particle.

6. The method for producing a luminous body according to claim 5, wherein the amount of the condensed phosphate deposited on the surface of the fluorescent particle is 2.0 to 4.0 wt % with respect to the weight of the fluorescent particle.

7. The method for producing a luminous body according to claim 1, wherein sodium silicate or sodium hexametaphosphate is used as a dispersant in the step (b-1).

8. The method for producing a luminous body according to claim 1, wherein the acid added in the step (b-2) is sulfuric acid.

9. The method for producing a luminous body according to claim 1, wherein the temperature of the slurry (S2) is kept at 60° C. or more and the pH of the slurry (S2) is kept at 6 or more when the step (b-2) is performed.

10. The method for producing a luminous body according to claim 9, wherein the temperature of the slurry (S2) is kept at 90° C. or more and the pH of the slurry (S2) is kept at 9.0 or more when the step (b-2) is performed.

11. A luminous body obtained by the method for producing a luminous body according to claim 1.

12. A luminous body comprising:
a fluorescent particle that is a strontium-containing phosphorescent pigment, in which a condensed phosphate is deposited on the surface of the fluorescent particle in an amount of 0.2 to 15.0 wt %; and
amorphous silica with which the surface of the fluorescent particle is coated;
wherein the condensed phosphate is a tripolyphosphate or tetrapolyphosphate salt of a metal which is selected from calcium, strontium, barium, aluminum, zinc, and cerium.

13. The luminous body according to claim 11, wherein the content of the amorphous silica in the luminous body is from 1 to 25 wt %.

14. The luminous body according to claim 11, wherein the content of the amorphous silica in the luminous body is from 1 to 25 wt %.
